(19) United States
(12) Patent Application Publication
(10) Pub. No.: US 2006/0252520 A1
(43) Pub. Date: Nov. 9, 2006

(54) Pari-mutuel wagering on large entrant pools system and method

(76) Inventor: Harry B. Platis, Lynnwood, WA (US)

Correspondence Address: HUGHES LAW FIRM, PLLC, PACIFIC MERIDIAN PLAZA, SUITE 302, 4164 MERIDIAN STREET, BELLINGHAM, WA, 98226-5583, US

(21) Appl. No.: 11/215,633

(22) Filed: Aug. 29, 2005

Related U.S. Application Data
(63) Continuation-in-part of application No. 11/129,606, filed on May 13, 2005.
(60) Provisional application No. 60/673,909, filed on Apr. 22, 2005.
(60) Provisional application No. 60/687,149, filed on Jun. 3, 2005.

(51) Int. Cl. A63F 13/00

(52) U.S. Cl. 463/28

(57) ABSTRACT

A system and method to provide pari-mutuel wagering on contests having large numbers of entrants. A series of wagering events are provided in the system. Each wagering event is configured to display a particular contest, for example: a poker playing tournament, a billiards/pool playing tournament, golf tournament, an automotive race, a motorcross race, a Marathon, and a tennis tournament and the like. Each tournament wagering event has a pari-mutuel wagering option and an exotic wagering option. The pari-mutuel wagering option allows users to wager on the top ranked individuals in the tournament. For example, the top 50 players in the world playing in the World Series poker would be listed in the individual pari-mutuel wagering option. The pari-mutuel wagering option also allows users to wager on the remaining 5000 players in the tournament in various formats. The formats include categorizing these players into groups organized for example, by last name, and placed into alphabetic groupings. The exotic wagering options allow for a pick six scenario, and exacta scenario, a quinella scenario, and a trifecta scenario, other exotic wagering options are also provided.

### RELATED APPLICATIONS

This application is a continuation in part of U.S. Ser. No. 11/129,606 filed May 13, 2005 which claims priority benefit to U.S. Ser. No. 60/673,909 filed Apr. 22, 2005 and this application claims the benefit of U.S. Ser. No. 60/687,149 filed Jun. 3, 2005

### BACKGROUND OF THE INVENTION

a) Field of the Invention

This concept deals with the area of betting referred to as pari-mutuel wagering which comprises a betting system where players wager on an event and the payout funds are distributed from a common pool. In essence, the pari-mutuel wagering is a form of betting where the losers' wagers are distributed amongst the winners. Pari-mutuel wagering occurs mainly in horse racing, as well as dog racing, or other state- and federally-licensed racetracks. Additionally, pari-mutuel wagering occurs around sporting events which are wagered on by private parties not licensed by the government.

b) Background Art

Wagering on sporting events such as horses, dogs, and other types of racing is profitable and a popular sport itself. Generally, individuals will decide to make a pari-mutuel bet or wager on horses or dogs which will be racing in a predetermined racing format. Betting houses exist where the racetracks allow individuals to place wagers on, for example, a horse to place first in a race, or two horses to place first and second in an exact order in a race. Individuals place the bets, and depending on the amounts of money wagered within the common pool on a specific horse the odds are calculated. For example, a favorite to win would likely have higher odds of winning based on the number of individuals placing a wager on that horse, consequently the payout will be relatively smaller because there's less risk associated with wagering on the horse. Prior to any payout, the house or racetrack will take a cut off of the top of the pooled wagering which is essentially a service fee for holding the wagering event.

There are many existing concepts which deal with how to bring the racing track to users via an online system, as well as improvements on the existing wagering systems. They include the following patents.

U.S. Pat. No. 6,837,791 (McNutt) discloses an interactive wagering system with totalisator selection. This patent deals with off track betting on races at racetracks. Referring to Col. 3 at line 24, a system is used to provide an interactive wagering service to users of various user equipment. An application can be run locally on, for example, a set-top box, personal computer, notebook, cell phone, or handheld computing device. The users can receive real-time videos from the various racetracks over a television wagering service. This might be over a channel or the Internet. Racing data may also be provided by, as referred to Col. 6 at line 3, information sources such as Axis pocket information network, and other suitable data sources. Also, totalisators may provide racing data, which themselves are computer systems used to handle wagers made at racetracks, or off track betting establishments and all use the interactive wagering system. The totalisators generate wagering odds in real-time, the odds are based on information on which wages are being placed, and are provided by companies such as Amtote International and may be associated with individual racetracks or groups of racetracks. With regard to the system architecture of this patent, standard data distribution and information systems include the use of servers,

satellite systems, cable systems, transaction logging equipment, databases, management subscriber systems, computer networks, Gateway interfaces, and the like. Suffice to say, the user of this system would log on to the local network, which would provide various race track betting options, as well as an account for the user to bet and win or lose funds in the account based on the outcome of the races.

U.S. Pat. No. 6,837,789 (Garahi) discloses systems and methods for cross-platform access to a wagering interface. This patent allows users to bet on various wagering sports. Referring to Col. 10 at line 63, the sport option allows the person wagering to select different sports and may include an auto racing, basketball, baseball, boxing, football, golf, horse racing, or any other suitable wagering sports. Each wagering sport may present unique wagering interfaces due to different relevant statistics pertaining to each sport. Once a wagering sport has been selected, the person wagering may be asked whether he or she wants the sport set as a default for subsequent access to the wagering interface.

U.S. Pat. No. 6,811,488 (Paravia) discloses a gaming system with location verification, the system provides an automated gaming service to one or more players in a computer-based environment with automated computation of wagers, payouts, and other gaming parameters. This gaming system can be implemented over the Internet and basically establish a virtual gaming environment. Accounts can be set up as debit type accounts where players fund or replenish the accounts in advance of the wagering using credit cards or other payment techniques. The system can use a pari-mutuel or guaranteed payout gaming format among others. Referring to Col. 8 at line 8, the automated gaming system may request information from the user such as age, location, and other information to insure players are not violating local laws or regulations by participating in certain gaming events. This is part of the registration process. Further down in Col. 8 at line 50, the player makes

wages deducted from the player's account therefore ensuring that the system or house is covered by the wager. Referring to Col. 9 at line 15, various events and games can be offered on the automated gaming system. Player might view attributes and/or games and decide to place a wager on one or more competitors participating in one or more games. For example a basketball game may be played between Duke and UCLA. Information which show point spread, minimum and maximum wagers, payout amounts and other information. With the browsing finished, players can place a wager and after the results of been verified, the gaming system computes the payoffs to the various wagers and provides these to the appropriate accounts.

U.S. Pat. No. 6,786,824 (Cannon) discloses a method, apparatus, and system for providing a player with opportunities to win a feature event award tied to a primary game such as a slot machine, video poker, or other electronic gaming machines. The feature event opportunity is earned by a player entering a live contest, and playing a series of machines networked together for qualification participation in the feature events. After playing the qualifying events, and referring to Col. 8 at line 60, when the date for the feature event has arrived, any player qualified for the feature event may be queried through a dialog box on a display screen as to whether they wish to participate in the next feature event. If the player chooses to make a wager in the upcoming feature events, event credits or unit entries are detected from the accrued pool of points for credits at the players gaming machine. Wagering events as discussed further in Col. 9 at line 40 may include live events such as sporting events like horse races, dog races, track and field events, ski races, vehicle races, track races and horse races. Further down at line 50, players might in addition to placing a wager for the event winner, may be allowed to place a wager for second place, finish, show, or other type of outcomes of the events.

U.S. Pat. No. 6,695,701 (Aronson) discloses a system and method for providing fixed odds and pari-mutuel wagering which allows the user to submit a wager to a fixed odds book or a pari-mutuel pool using an interactive wagering application, as well as a conditional wagering option. Referring to Col. 16 at line 61, as part of creating a wager, the application provides the user with the ability to select wager options for the ability to designate a conditional wagering option. The user may create a wager for a specific race to be submitted to the fixed odds book. Also, the interactive wagering application may automatically submit the wager to a pari-mutuel pool if the user designated the wager as a conditional wager.

U.S. Pat. No. 6,688,978 (Herman) discloses an events contest method where a participant is selected from a predetermined size of event competitors and the participant places a wager on a rank selection where the ranking is based on a statistical index. In Col. 5 at line 39, at a predetermined point in the event or events wagered upon, such as completion of the event for events, halftime, or the like, and indexes calculated for each participant based on the aggregate performance of the participants selections, meaning that the participants in the wagering event choose game players within each team and an index is the calculated to rank the wagering participants score based on the aggregate performance of the participants team game players within various categories. This seems to be similar to ranking of individual players in a fantasy sports game scenario.

U.S. Pat. No. 6,508,709 (Karmarkar) discloses a virtual distributed multimedia gaming method and system based on actual regulated casino games or virtual gaming and is provided at a remote location either on or off site of the casino premises using live multimedia video or restricted prerecorded video from autonomous randomly selected live casino games. A remote player station is included and has a display and other functions for legally authenticating the remote player to place a bet. The remote player station also provides gaming information to enable the remote player to receive payout. Simplified wagering rules enable the remote player to bet either for or against the actual player using either a live casino multimedia video signal or restricted randomized casino multimedia game video.

U.S. Pat. No. 6,358,150 (Mir) discloses a method and apparatus for pari-mutuel historical gaming with instant payoffs on actual past events. In operation, a player attempts to choose the winners of an unknown past event, some information or skilled data may be shown on the video display such as the relative past performance of competitors, after the player makes a selection of winners, the identity of the events is revealed and a video segment of the events is displayed with the actual owners presented. If player picks the correct winners, he qualifies for instant payoff determined in accordance with pari-mutuel methods.

U.S. Pat. No. 6,309,307 (Krause) discloses a casino/lottery/sports style wager and game for pari-mutuel racing operations by using unique rules and formats to govern the wagering on the pari-mutuel race and reflecting existing games from casinos, lotteries and sports. Referring to Col. 5 at line 16, the following working components are offered to pari-mutuel race operators including a blackjack fast or last game where players choose whether the total of the starting numbers of the first four finishing animals or the last four finishing animals will sum closer to 21 without going over. Similarly, baseball game allows players to bet on either the home team, meaning even-numbered animals, or the away team, odd-numbered animals, or the finishing position of each animal equals the number of runs scored by that animal.

U.S. Pat. No. 6,236,900 (Geiger) discloses a method and system for Internet-based competitive event prediction where participants submit predictions of future events, obtain words for correct predictions and suffer penalties for incorrect predictions. Each competitive speculation is defined by number of future events such as sporting contest, elections and debates, stock price fluctuations and the like. Straight predictions can be submitted, future combination predictions, and other variations. When an event occurs, points are awarded or subtracted from the participants point holdings.

U.S. Pat. No. 5,749,785 (Rossides) discloses a communication system using bets which allows people to place, accept, and settle bets without utilizing a bookmaker. The system enables individuals to settle disputes, change their bets, and place special types of bets for the purpose of demonstrating probability in quantity estimates. Referring to Col. 4 at line 53, the computer system allows people to use bets efficiently by accepting and settling bets for the purpose of communication. System allows people to post bets, except, change, and settle the bets and thus also settle disputes. A key object of the invention is to allow people to express through the payoff odds what they think about the actual odds.

U.S. Pat. No. 5,746,657 (Ueno) discloses off-track betting systems where a receiver receives live racing from a race track and displays the race to unspecified betters who can watch the race. The betters are enabled to enter bets on the outcome of the race through a television or fax. In Col. 1 at line 53, the off-track or online betting system is applied to a horse race, bike race, speed boat race, or an auto race. Further in Col. 3 at line 52, the invention enables betters to place bets on races run at every part of the country, while watching them at home, thus avoiding traffic expense.

### SUMMARY OF THE INVENTION

It is an object of the current embodiment to provide a system and method for pari-mutuel wagering on contests such as poker tournaments, pool tournaments and the like, where the tournaments have large number of entrants or competitors.

The system and method utilizes a series of wagering servers and clients connected over a network. Additional third-party sites such as banks, cellular systems, ATM systems, and others are used to transfer information and support the system and method.

The system and method utilize a wagering application which accesses a wagering database.

The wagering application has a backend application interface and a frontend application interface. The backend application interface allows the individuals hosting the wagering application to customize it for varying sizes of tournaments.

The front end application is designed for individuals wishing to pari-mutuelly wager on players within the tournament. The users can access a plurality of wagering events or options including wagering on the top-ranked individuals in the contest to place first. Additionally the users can wager on unranked players who may be playing in the tournament for the first time and likely do not have a track record to be ranked. These unranked players are accessible to be wagered on in various group classifications.

The odds change on the various group classifications or individually ranked players depending on the amount of funds wagered on that individual or group to win.

Additional exotic bets such as pick six, exacta, quinella, trifecta, and other type of bets which have been used in the sports racing industry are also provided.

### BRIEF DESCRIPTION OF THE DRAWINGS

FIG. 1 is a schematic diagram of the wagering system,

FIG. 1A is a schematic diagram of a casino wagering tournament,

FIG. 1B is a schematic diagram of a pool/billiards tournament,

FIG. 2 is a block diagram of the overall wagering system architecture,

FIG. 3 is a block diagram of the casino application and database,

FIG. 4 is a block diagram of the banking application and database,

FIG. 5 is a block diagram of the wagering application and database,

FIG. 6 is a block diagram of the wagering back end application and database,

FIG. 7 is a block diagram of the wager front end application and database,

FIG. 8 is a flowchart of the wagering application homepage,

FIG. 9 is a flowchart of the wagering application user account,

FIG. 10 is a flowchart of the wagering application tournaments to view,

FIG. 11 is a flowchart of the wagering application user picking tickets,

FIG. 11A is a block diagram of the method of calculating odds on large entry tournaments,

FIG. 11B is a block diagram of the method of calculating running odds on large entry tournaments,

FIG. 11C is a flowchart of the wagering application showing transfer of funds,

FIG. 12 is a flowchart of the wagering application user choosing individual wagers,

FIG. 13 is a flowchart of the wagering application user choosing field wagers,

FIG. 14 is a flowchart of the wagering application user choosing exotic wagers,

FIG. 15 is a flowchart of the wagering application user placing wager amounts,

FIG. 16 is a flowchart of the wagering application during transfer of funds,

FIG. 17 is a flowchart of the wagering application user viewing exotic wager options,

FIG. 18 is a flowchart of the wagering application user choosing a multiple event wager.

### DETAILED DESCRIPTION OF THE PREFERRED EMBODIMENTS

This concept deals with a process for enabling a web site to allow individuals to make multiple forms of pari-mutuel online betting and is designed around events having a large number of entrants such as the currently popular World Series Poker, the World Nine Ball Championship, Nascar Races, Motorcross events, golf tournaments, and other related sporting events having large groups of competitors or entrants. The concept is further designed to allow online viewers to place pari-mutuel bets on existing online tournaments. This allows staged pari-mutuel online betting based on predetermined stopping points within the game play or tournament play. Other forms of pari-mutuel betting on tournament or game play are also provided.

Generally speaking, the current embodiment of the wagering system provides for individuals to access a web site which has a listing of tournaments currently scheduled or underway, and within the individual tournament access lists of the individual players and the stage of the various matches being played.

Users of the wagering system can place a pari-mutuel style wager on various players within the tournaments, or on various exotic criteria which the wagering system web site provides.

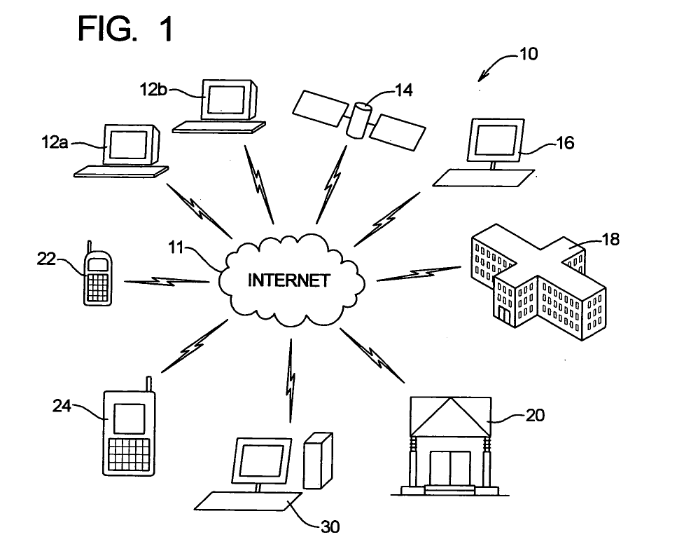

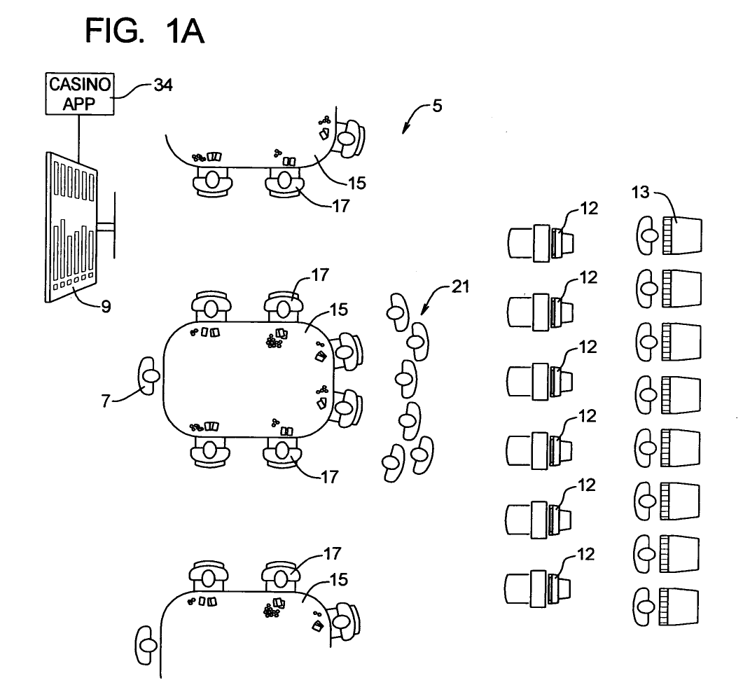

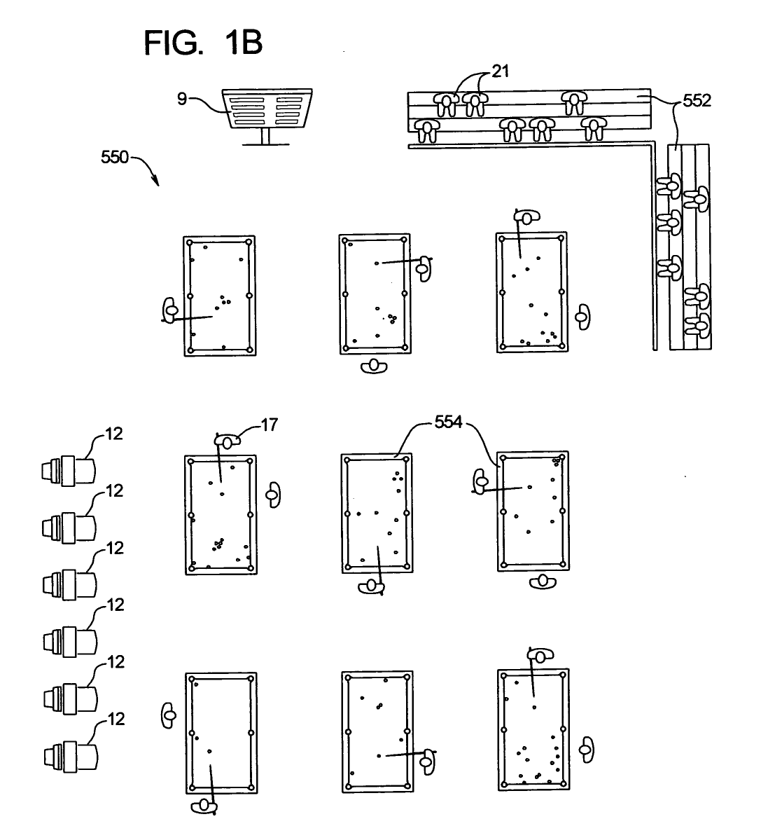

Now referring to FIG. 1, the wagering system 10 is generally comprised of the wagering server 30 which is connected to the Internet 11. Various outside components which have access to the Internet 11 feed into the wagering server 30 or receive information from the wagering server 30. These outside components include desktop and laptop clients 12A and 12B, satellites 14, other gaming servers 16, casinos 18, banks and financial institutions 20, cellular phones 22, and personal digital assistants 24. Instances of the wagering server's application can be run at any of the various listed components; the application of which will be discussed further below.

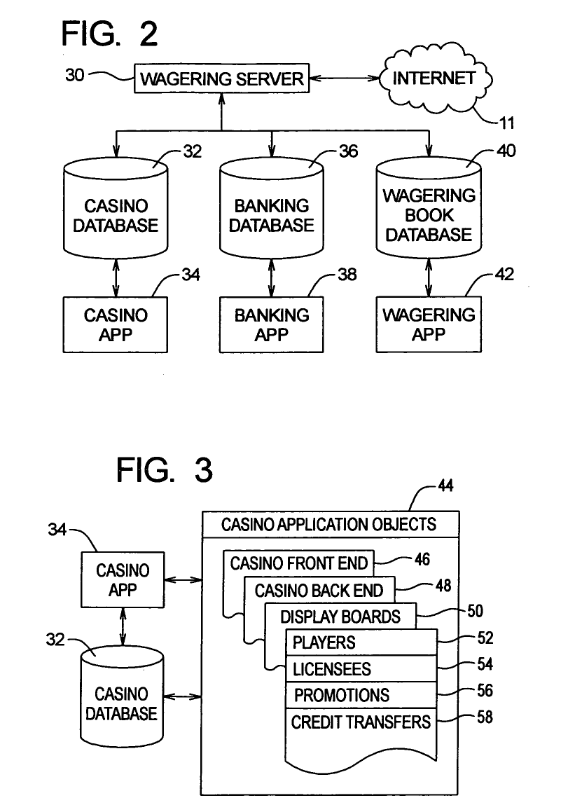

A brief discussion of the system architecture which comprises the wagering server 30 will now be discussed. Referring to FIG. 2, a wagering server 30 is connected to the Internet 11, and the wagering server has within its memory a casino database 32 which correlates to a casino application 34, a banking database 36 which correlates to a banking application 38, and a wagering book database 40 which corresponds to a wagering application 42. Although the various databases are shown separately, it is conceivable that these individual databases could be provided in one single database such as a Microsoft™ SQL database, and the wagering server could easily be shown as a Microsoft™ BizTalk™ server.

Similarly, the applications may run from a single database and have various objects correlating to the applications for implementation of instances of the applications.

Also, the wagering server system 30 can be ported to or licensed to multiple affiliate server sites 16. For example, authorized affiliates could have a system architecture of the wagering server system 30 resident on their gaming and/or betting servers 16 as seen in FIG. 1, as well as located on various cellular network affiliates 22, and may also include affiliates such as the Blackberry™ network which would license the wagering server system 30 to run on their various networks and allow access of the personal digital assistants 24 to the wagering service 30.

A land-based affiliate having the ability to run both the backend and front end of the wagering server system 30 as discussed below would be for example a single casino affiliate 18.

Referring back to FIG. 2, the affiliates as discussed above, may have access to various portions of the wagering server 30 such as access to the casino database 32 and application 34, the banking database 36 and application 38, or the wagering database 40 and application 42. This would be dependent upon the various authorized or licensed configurations which the individual's hosting the wagering server 30 might configure per individual specifications.

Still discussing the system architecture and referring to FIG. 3, a plurality of casino application objects 44 is provided to enable the casino application 34 to operate. These casino application objects 44 reside within the casino database 32 and are accessed by the casino application 34 when the various objects are initialized.

The casino application is provided to enable casinos 18, FIG. 1, to have various customized casino or wagering applications which would then integrate with the casino computer systems.

For illustration purposes, implementation of the system will be discussed in the context of a large poker playing tournament such as the World Series of Poker™ and also be discussed in the context of a large billiards or pool tournament such as the World Nine Ball Pool Championship.

Many times, the location of the tournaments for poker playing occur in the various casinos such as the MGM Grand™. It is beneficial to have readily available client terminals 12, FIG. 1, located within the casino 18 for individuals who are following the poker tournament and the various players within the tournament to make wagers on the outcome of a game or the tournament by utilizing the casino application 34.

Additionally located within the casino will be display boards such as a large liquid crystal display device, or reader boards.

Referring to FIG. 1A, a typical casino poker tournament 5 is shown. Generally poker tournaments such as the World Series of Poker™ will attract groups of players 17 upwards of 5000-7000 players or entrants. The type of poker match which will be played is usually a form of Texas Hold'em, a very popular form of poker currently being played.

The players will congregate around a poker table 15 and play a specific game to progress in the tournaments. A monitor or official 7 may or may not be present at the poker match, and during the higher profile matches which might have celebrity-type poker players, spectators 21 may congregate to watch the match. Prior to the beginning of the play, spectators can make bets by using their handicap skills to determine who would likely be a good person to bet to win the particular match or to lose a particular match. Further, spectators can view and access the reader board 9 which is connected to the casino application 34. Also, after viewing the particular odds for individual listed players 17 or within the various betting options which will be discussed below, the spectators or account users can enter in the desired pari-mutuel wager on a various player 17 within or using the client terminals 12 located within the casino 18.

Referring to FIG. 1B, a further example of a venue or tournament which generally has a large number of entrants is a pool or billiards tournament 550. Many times these tournaments will have 64, 128, or 256 matches playing simultaneously. Thus there may be as much as 500 or more players starting at the beginning of the tournament.

A typical tournament will have various formats, one format being a ring game format. There may be as many as 36 tables 554 set up in the pool tournament 550 and five players 17 may be assigned to each pool table 554. The five players will play a chosen game such as nine ball and take turns attempting to run the table. The top two players who win the most games of the five will move on to the next group of five players, thus marching up the tournament bracket structure to the final match.

Additionally, another format would include contests between two or more people or teams of doubles or quadruples, either mixed teams, such as male and female team members, or teams of chosen nationality and the like. The individuals or teams would then play the predetermined best number of wins to move up the tournament brackets.

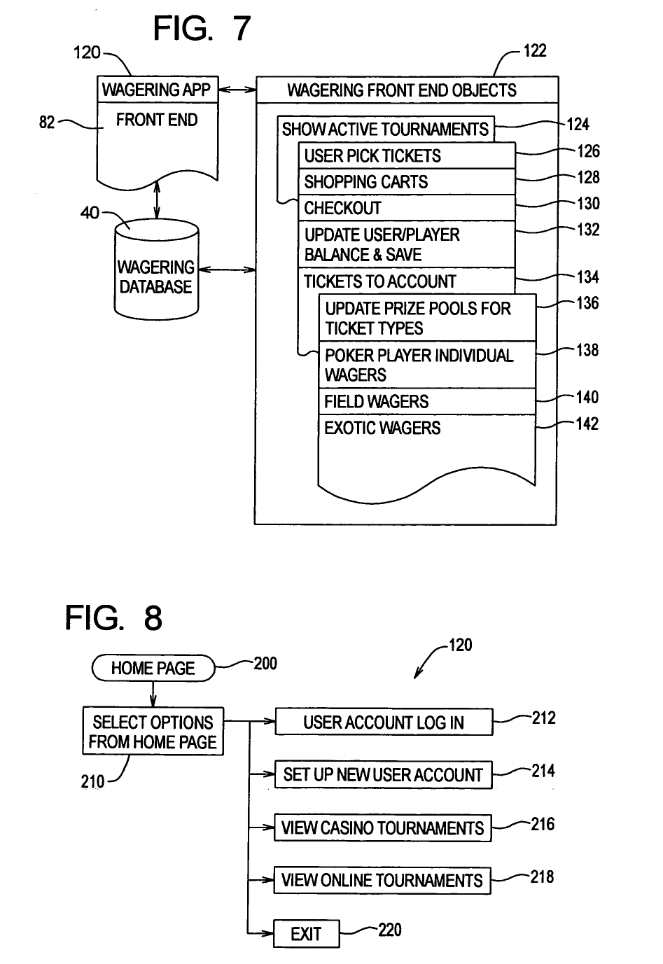

During the tournament play, spectator seating 552 may be set up and spectators 21 may view the tournament play. During the pre-game warm up, spectators can use their handicapping skills to measure the likelihood of one player winning over the others or the strengths and weaknesses of the various teams. Spectators can then use their cell phones 22, FIG. 1, personal digital assistants 24, or other means including other clients 12 which may be available in the forum of the pool or billiards tournament location 550, FIG. 1B. The spectators 21 can access the wagering server 30 through the wagering application 120, FIG. 7, as will be discussed below and then place their bets.

A discussion of the wagering system 10 and how the wagering system provides information to users to enable the bets to take place will now be discussed.

Referring back to FIG. 3, the casino objects 44 further include a casino front end object 46, a casino back end object 48, a display board object 50, a players object 52, a licensees object 54, a promotions object 56, and a credit transfers object 58, all which can be used to create various instances of the casino application 34 depending on the desired use at the various locations such as within the casino or at a remote user location.

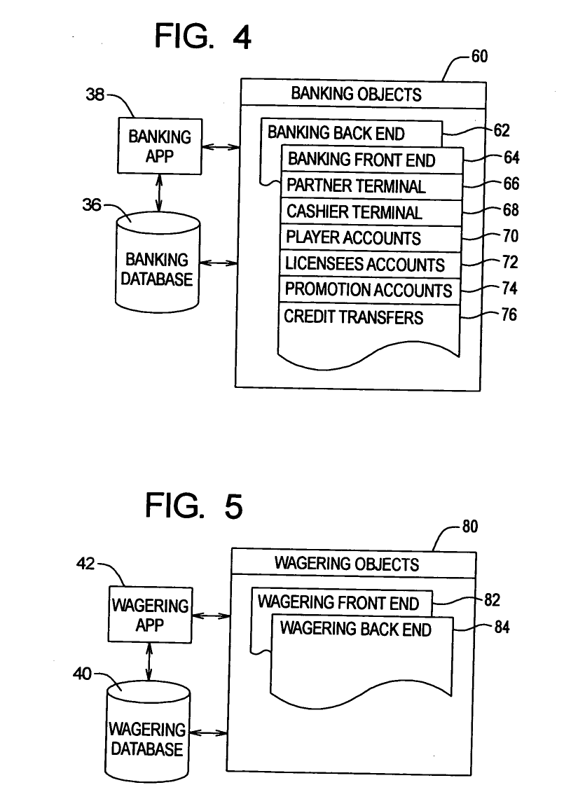

While using the wagering system 10, individuals are required to set up accounts to receive and transfer funds during the wagering process. To support such activity, and referring to FIG. 4, a series of banking objects 60 are provided which reside within the baking database 36 and which are enabled in the banking application 38. Generally, the banking application has a front end and a back end, meaning that the front end deals with the interface for account users and general public, and the back end enables the individuals maintaining the wagering system 10 to implement various configurable portions so that the wagering system 10 can provide accurate information. Still referring to FIG. 4, the banking objects include the banking back end object 62, banking front end object 64, partner terminals 66, cashiers terminal object 68, player account's objects 70, licensee's account's objects 72, promotion account's objects 74, and credit transfers objects 76.

One of the main purposes of this wagering system 10 is to allow individuals to wager pari-mutuel style betting on the individual players within a tournament setting. To implement such a service, a wagering application 42 has been designed as seen in FIG. 5. The wagering application 42 resides in the wagering database 40 which holds also a series of wagering objects 80.

The wagering application has two main components, wagering front end object 82 and the wagering back end object 84.

Users of the wagering system 10 will generally see the wagering front end application object 82 on one of the client's terminals 12A, see FIG. 1.

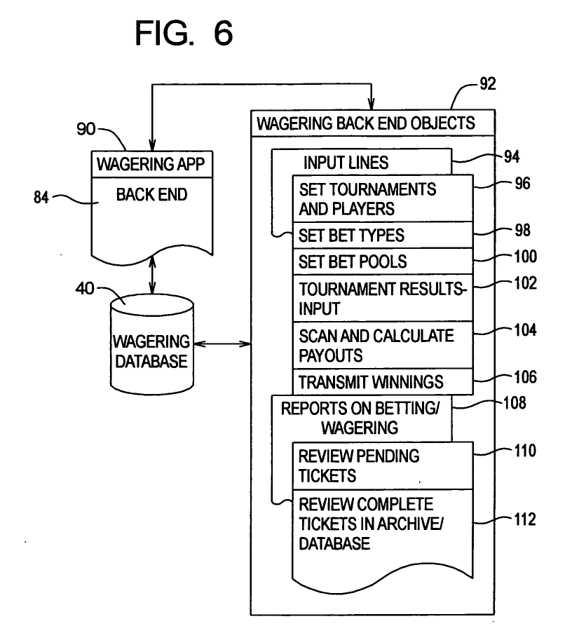

Referring to FIG. 6, and discussing first the wagering back end objects 92, the individuals who host the wagering system 10 on their wagering servers 30 will need to provide various information for the tournaments which are being played either online or off-line in various tournament hosting locations such as casinos 18.

To support this configuration, wagering back end objects 92 have been provided in the wagering database 40 and can be initialized in the wagering application back end 90. These wagering back end objects 92 include input lines 94 which have a subset of back end objects including entering tournaments and players in a set tournament and players object 96, an application to allow various types of betting configured in the set bet types object 98, an application for setting pool bet types in the set bet pools object 100, an application for displaying tournament results in the tournament results input object 102, an object for scanning and calculating payouts 104, and an object for transmitting winnings 106. Also included in the back end objects are reports on betting and wagering 108, an object to review pending tickets 110, and an object to review the complete tickets in an archive or database 112. Of course these objects are further configurable depending on the specific use involved.

Referring to FIG. 7, a discussion of the wagering front end object's 122 will now be provided. The wagering database 40 has resident within it a series of wagering front end object's 122 which are initialized through the use of the wagering application in the front end instance 120.

These front end objects include an object to show an active tournament or tournaments 124, an object to allow users to pick the tickets 126, an object to allow users to implement a shopping cart 128, an object to allow individuals to check out 130, an object to allow users to update their accounts and save 132, an object to list the tickets to a user's account 134, as well as other objects such as objects to update price pools for ticket types 136, objects for player individual wagers 138, objects for field type wagers 140, and objects for exotic type wagers 142.

Generally speaking, the wagering application front end 120 will provide the user with various types of wagering events unique to the pari-mutuel style wagering on tournaments with large numbers of entries.

A user will normally access the wagering application front end 120, FIG. 8, through a client computer 12, personal digital assistant 24, cellular phone 22, or the homepage 200.

What follows is a description of the current embodiment for implementing various system components within the wagering application 42, FIG. 5, and it is conceivable that other methods and operations will implement the same overall result which is to enable the various betting or wagering options on a pari-mutuel style wagering event for tournaments having large number of entries.

The users of the wagering system 10 can optionally download a resident software copy of the wagering application 42 and either the front end wagering application 120 FIG. 7, or the backend wagering application 90 FIG. 6, and receive XML feed from the wagering server 30 FIG. 2 which updates the ongoing tournaments and odds as they progress.

Referring to FIG. 8, a general method describing the flow of the user data at the homepage 200 will now be described. The user can select various options from the homepage at step 210. The steps include a user account login 212, a set up new user account 214, a view casino tournament 216, a view online tournament 218, and an exit step 220.

Additionally, the user can view advertisements on his homepage 200 as well as follow various tournament events which have been broadcast on a simulated odds board in the web site as well as the odds board or reader board 9 located within the casino poker tournament 5 FIG. 1A.

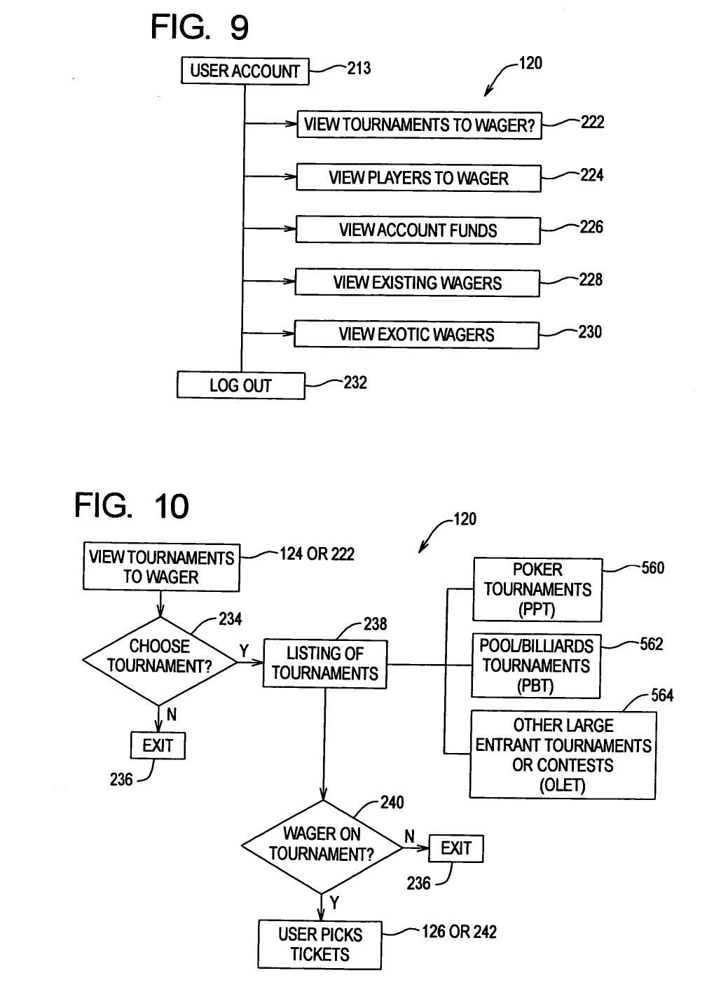

In the current embodiment, the user has already set up a new user account 214 and has chosen to login to the users account 212, and therefore referring to FIG. 9, at the user account screen 213, the user can take advantage of various options to make wagers and review existing placed wagers.

These options include a view tournaments to wager page 222, a view players to wager page 224, a view account funds page 226, a view existing wagers page 228, a view exotic wagers page 230, and a logout page 232.

Within the view tournaments page of component 222 are listed number of various large entrant tournaments or contests for the user to make wagers within. Referring to FIG. 10, the user can choose to view the tournaments to wager on at page 222 and then is directed to choose various tournaments at step 234. If the user decides to choose to wager on a tournament, a listing of tournaments is provided at step 238. Within this listing of tournaments the user has the option of choosing poker tournaments 560, pool/billiards tournaments 562, or other large entrant tournaments or contests 564 as may come available. The user may then choose to view one of the subcategory tournament listings at step 240 and then the user can pick various ticket items listed under each tournament subheading at step 242. The user pick a ticket step 242 is an instance of the user pick ticket object 126 as seen in FIG. 7.

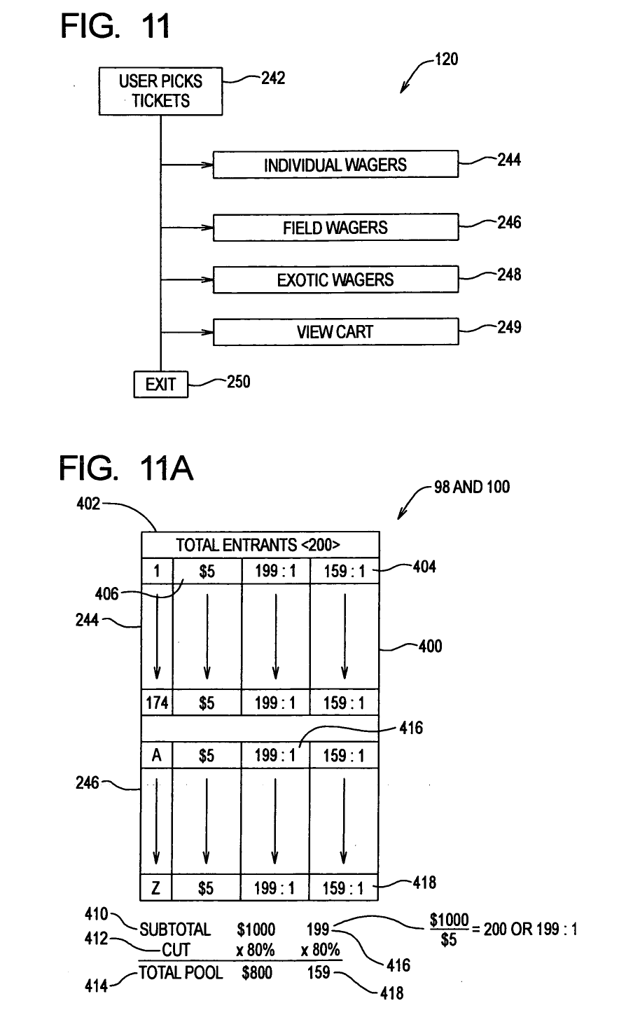

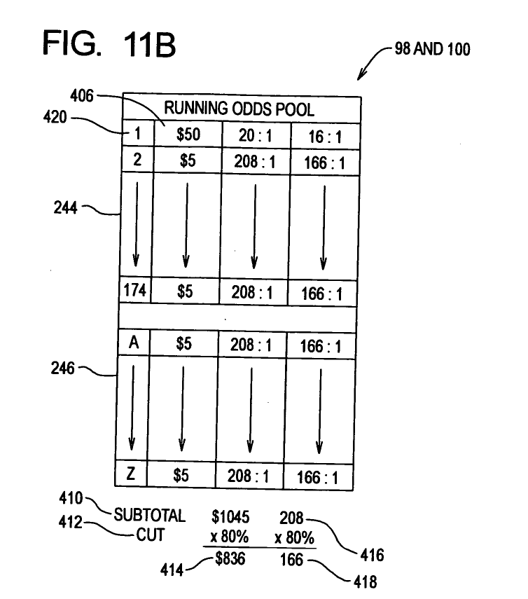

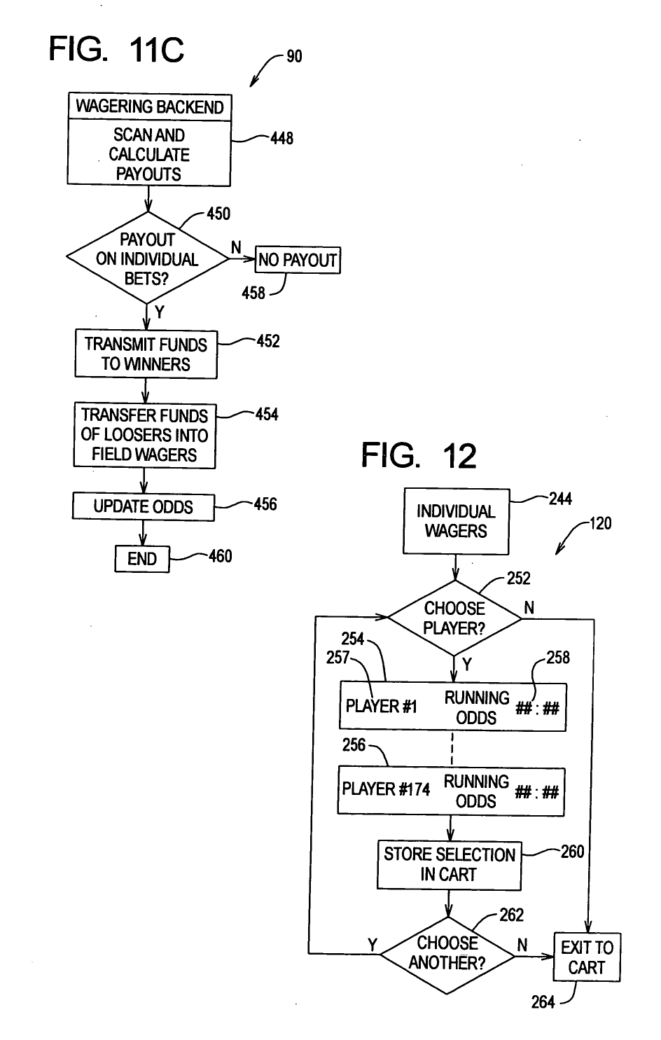

Referring now to FIG. 11, within the user picks ticket option step 242, various types of wagers within that particular tournament are provided. These wagers have been preconfigured by the system administrators hosting the wagering system 10. The system administrators can pre-configure the wagering options by utilizing the back end wagering application 90 as seen in FIG. 6.

Still referring to FIG. 11, after an account user has decided to wager on a particular contest or large entrant tournament, the user has the option of picking various betting tickets by using object user pick tickets 126 as shown in the step 242. Various classes of wagering tickets 242 can be utilized for each type of tournament. The classes include an individual wager class as shown in the sub-application individual wagers 244, a field wager class as shown in the field wagers sub-application 246, as well as an exotic wagers class as shown in the sub-application exotic wagers 248. An instance of each of the above-mentioned classes can be initialized for each of the tournament types.

For example, a user might choose to place a field wager on a group of players within one of the poker tournaments. Therefore, the account user would enter into the poker tournament application at step 560 as seen in FIG. 10 and the user would be presented with a series of ticket wagers configured for the poker tournament. These include a poker tournament individual wagers 244A, a poker tournament field wagers 246A, a poker tournament exotic wagers ticket at 248A.

Similarly, an account user may choose to wager on action occurring in the pool/billiards tournaments. After entering into this pool billiards tournament sub-application at step 562, FIG. 10, the user would be provided with a series of wagering tickets at step 242, FIG. 11, each wagering ticket would be configured to the billiards tournament.

For example, an instance of the individual wagers class 244 would be provided and configured as a 512 player billiards tournament individual wagers sub-application 244B, the field wagers class 246 would be initialized as a 512 player billiards tournament field wagers sub-application 246B. Similarly, the exotic wagers class 248 would be initialized as a 512 billiards player tournament exotic wagers sub-application 248B.

Referring first to FIG. 12, the user may choose to implement the front end wagering application 120 and make an individual wager on one or more particular players within the 5000 poker player tournament 244. At step 252, the user has the option of choosing from the list of players and if the user does not wish to choose a player, he can exit to the cart at step 264. If the user wishes to choose a player to make a wager on, he is allowed to choose from a listing of individual players at step 254.

Within this listing of players 254 are the player's names 257 as well as the running odds 258 on each of the players.

As mentioned previously the current embodiment allows for configuration of pari-mutuel style wagering on large entry tournaments and sporting events such as the World Series of Poker™ and World 9 Ball Pool Championship. The World Series of Poker™ as previously discussed may have up to 5000 to 7000 entries. Consequently a method of categorizing and allowing individual users of the wager system 10 to place bets on players within the pool is provided.

Referring to FIG. 11A, the users hosting the wagering system 10, FIG. 1, can implement the back end wagering application 90 and run an instance of the set bet types 98, FIG. 6, and the set bet pools 100, FIG. 6, as is shown in FIG. 11A. The current embodiment in FIG. 11A shows a wagering option on a particular tournament with approximately 200 entrants. The pool is broken up into two main sections, the individual players wagering 244 and the field wagering 246.

The top 174 players are each assigned their own betting tickets 404. The betting ticket has the currently pooled wager amount 406, the precut odds 416, and the post cut odds 418 listed. As previously mentioned, the administrators of the sites will enter a minimum base wager for each contestant which is evenly split to create a base set of odds. Similarly, in the field wagering portion 246, the letters A through Z are shown as field wagers. This is one way of categorizing many additional entrants into subgroups. It is conceivable that the subgroups could be categorized by numbers instead of letters but for simplicity sake letters are provided. The letters correspond to the individual players last name. For example, all of the players with the last name starting with the letter A can be wagered on in the field wager portion 246. The precut odds 216 are shown calculated by the subtotal of the funds available within the pool 410 divided by the amounts of each wager 406. For example, the pool wager subtotal 410 is $1000, this will be divided by an individual entrants wager amount 406 in this case $5 which leaves the payout as 200/1 or in other words the odds of 199:1. The house or the administration or host of the wager system 10 will generally take a cut of the wager off the top. This cut 412 is a set percentage in this case 20% of the total. The total pool 414 available for distribution of winnings his $800 and the post cut running odds at the initialization of this particular event are 199:1, the precut odds 416, multiplied by the cut percentage 412 of 80% leaving a final post cut running odds at the initialization of the event to be 159:1.

Once the running odds pool is set for the particular tournament and the entrants are posted, individual account users can access the wagering events through the wagering application 42, FIG. 5, and place their wagers on their chosen players. Referring to FIG. 11B, as the wagers are placed within the various player pools 406, the odds begin to change. For example, player one is considered a favorite 420 and has a cumulative pool of $50 placed for him to win. Consequently, the total pool for the event increases from $1000 to $1045 at 410, which increases the distribution of post cut dollars to $836. Similarly, the odds for the player 1 to win decrease thus reducing the payout from 199:1 to the currently posted 20:1. Also, the increase in pooling funds increases the odds ratio for the other players from 199:1 in the precuts odds 416, to 208:1. The final payout if one of the non-favorites wins would be 166:1.

At the end of a particular event, the wagering backend application 90 as seen in FIG. 11C, will scan and calculate the payouts. The wagering backend scan and calculate payouts application 448 will first check to determine if a payout on an individual bet has been made at step 450 if no payout has occurred, then the application ends, but if a payout has occurred then the application will transmit funds to the winners at step 452. If for example a player drops out of the tournament, the funds wagered on that particular player's entry will be moved into a predetermined position. This predetermined position in one form will be the odds-on favorite at the time that the player drops out of the tournament. Therefore, the running odds will be recalculated based on the reallocation of the funds into a different entry account along with the reduction in the playing field. Another pre-arranged allocation would later be deposited.

Referring back to FIG. 11C, once the funds are transferred into the field wagers at step 454, the application updates the odds at step 456, and then either continues to scan and calculate payouts at step 448, or ends at step 460.

We will return to the discussion of the various wagering events options.

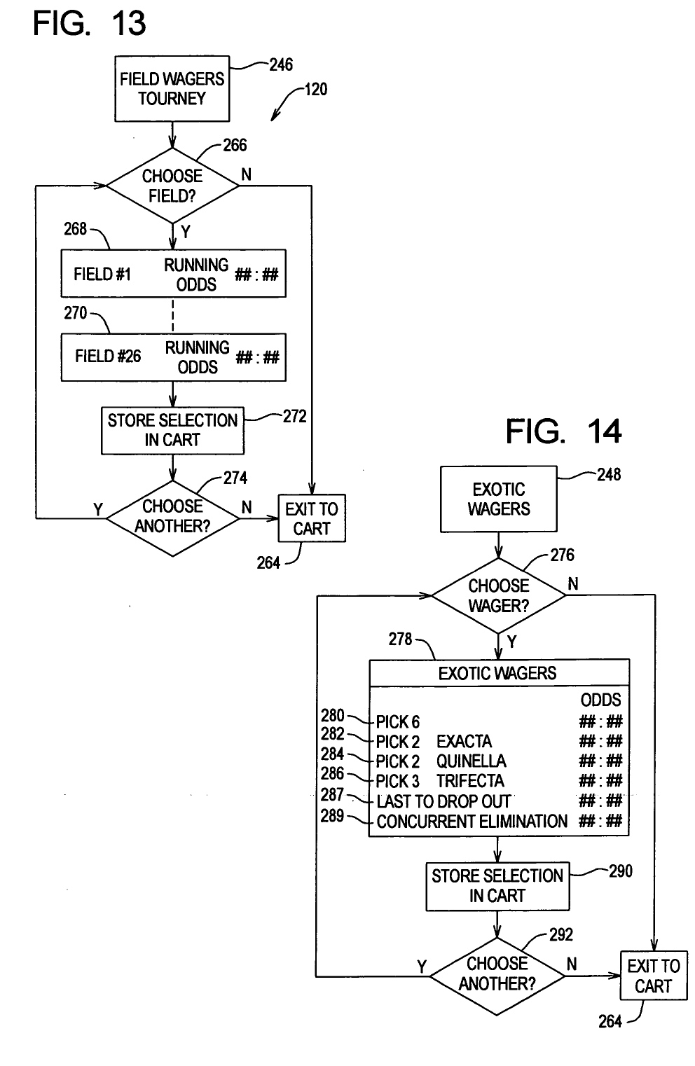

Referring back to FIG. 12, the account user can choose a player to place a wager on at step 254, and then store his selection in the cart at step 260. The account user is then given the option to choose another ticket at step 262 or exit to the cart at step 264. Referring back to FIG. 11, the account user may also wish to place a field wager at step 246. Referring to FIG. 13, the user will choose to view the tournament field wagers at step 246, and choose a field at step 266.

In this particular embodiment, the account user has the option of choosing between fields #1, 268 through fields #26, 270. These fields correlate back to the field wagers 246 seen in FIG. 11A and 11B.

The account user chooses a field and stores a selection in the cart at step 272. The account user has the option of choosing another field bet or ticket at step 274 and in this particular embodiment the account user chooses to exit the cart at step 264. Referring back to FIG. 11, the account user may also wish to place an exotic wager at step 248.

Because of the many different variables affecting large entry tournaments, the range of wagers can be increased from what has historically been provided in standard pari-mutuel wagers on horse track racing to include other types of exotic wagers. Some implementations of such exotic wages will now be discussed.

Referring to FIG. 14, after choosing the exotic wagers at step 248, the account user is given the option of choosing particular exotic wagers through a pulldown menu of some sort which has listed wager options within a screen at step 270.

Some of the various exotic wagers which the user can take advantage of are for example a pick two exacta wager at 282. This pick two allows the account user to wager on the outcome of the top two participants in the event winning in the exact order as described in the pick field.

Another exotic wager is a pick two quinella, 284 which allows an account user to wager that the top two participants of an event will win in any order.

Also provided in the exotic wagers would be a pick three trifecta 286 which would allow the account user to wager on the top three participants of an event winning in an exact order.

More exotic wagers would include the last participant to drop out at 287, for example would occur when during the tournament there are 100 players left in the tournament and the wagering system 10 allows users the ability to select and bet on the next player to be eliminated from the tournament.

Similarly, an exotic wager with a high payout and extremely high odds of winning would be a pick six 280 where the account user would be able to choose the top six finishers within a tournament.

Still other exotic style wagers will be discussed below. Still referring FIG. 14, the various selections are stored in the cart at step 290, and the account user is given the option to choose another ticket at step 292. The user can then exit to the cart at step 264.

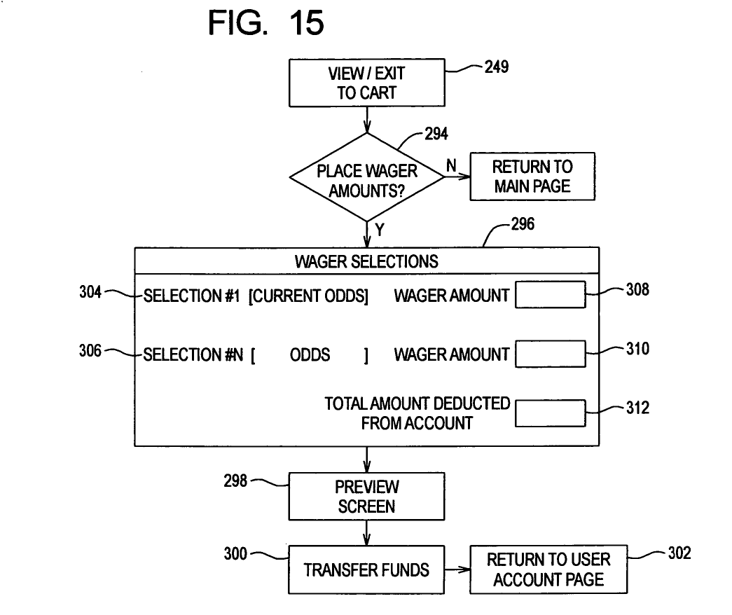

Referring back to FIG. 11, after the user has made his or her wagers, the user can view the cart at step 249, this takes the user to the view cart screen or method at step 249 in FIG. 15. The user can choose to place various wagers within the chosen wager selections. The user is allowed to place a wager amount at step 294 and if he so chooses can access the wager selections at step 296 which he previously saved in the above mentioned steps. For example, within step 296, the user can choose to wage an amount for selection number one 304 which is showing the current odds the user has the option of wagering an amount in the wager amount field 308. After entering in the various amounts to wager for each selection, a total amount deducted from the account is shown in field 312.

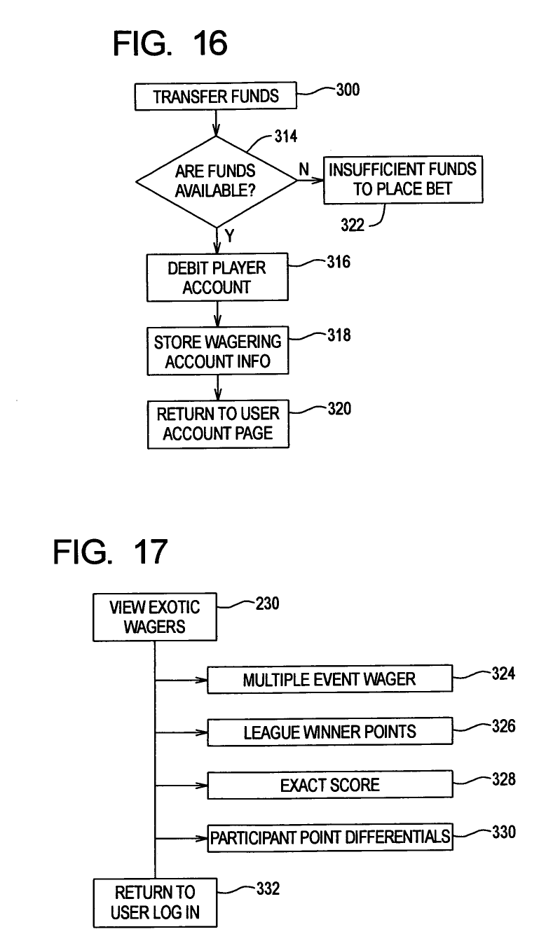

The user then previews the wagers to be entered at step 298 and initializes the transfer funds at step 300. Once the funds are transferred the user can return to the main user account page at step 302. Referring now to FIG. 16, the user can have their funds transferred at step 300. First the funds within the users accounts are checked at step 314. If the user has available funds then the funds are debited from the users account at step 316 and stored into the wagering account location at step 318. If insufficient funds are determined at step 322 then the user is allowed to return to the cart wager selections at step 296 of FIG. 15 to modify the wagering amounts. Once the amounts are validated, the user can store the wagering account information at step 318 at FIG. 16, and then return to the user account main menu at step 320 to track the progress of the users various wagering tickets.

As previously discussed above, users may also wish to access other exotic style wagers. Referring to FIG. 17 these wagers could be for example multiple event wagers at step 324. Such a multiple event wager would allow participants to bet on the outcome of multiple tournaments and the potential top participant in up to 50 events within the pari-mutuel setting. This would be similar to the super six as allowed in various racetrack settings but enabling up to 50 events concurrently to be wagered upon. This concurrent event feature would also enable wagering to occur on multiple tournament events either being played concurrently or during a series of events such as the World Poker Tour™ Tournament schedule.

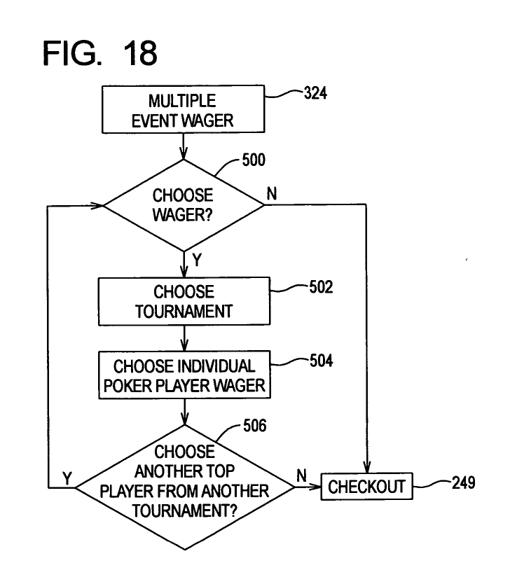

Referring to FIG. 18, the user may choose to wager a multiple event wager at step 324. The user is then allowed to choose a particular tournament at step 502, followed by choosing an individual poker player to wager upon step 504 which would be a similar process to steps 244, FIG. 12, and steps 246, FIG. 13 as previously discussed above. After the account user has chosen players to win the various tournaments, the account user can checkout and then place his or her various wagers at step 249.

Additionally, still referring to FIG. 17, another exotic wager option would be a league winner points system at step 326. Users would be given the option of choosing the winner of a series of events where the winner is based on a points system which would be in place for the lifetime of the various events similar for example to a NASCAR™ racing league or the World Poker Tour™ season where points are awarded to participants for placement in the various tournaments and where at the end of the season, the winner is decided and the pool pays out to the various account winners who selected the appropriate winning player.

Still referring to FIG. 17, an account user may choose an exact score wagering event at step 328. This exact score wagering event would allow users to bet on a player who has a certain number of for example, chips at the end of certain event, a player who has drawn a certain hand during a poker match or tournament, a pool player who is successful at running a certain number of tables, or other type of variable outcome events which are not controllable by outside forces.

Additionally, account users can choose to wager participant point differentials at step 330. This particular wagering event would allow bets on the outcome of the particular events such as the point differential between the participants within a match or more commonly known as the spread, and which would allow account users to choose potentially correct spread differentials. For example, in the case of an over/under total, the user who selects the total number of points in the events for both teams and is the closest to that number without going over would win the pool.

Additional types of wagers include:

A win bet or wager, a win bet includes choosing a winner for a particular tournament.

A place bet or wager, where the user chooses an entrant who finishes second place in a particular tournament.

A show bet or wager where a user chooses to wage on an entrant who places third in a particular tournament.

A final table bet or wager where the user chooses an entrant who is likely to make it to the final table round in a particular tournament.

A pick six bet or wager where the user chooses six entrants to make it to the final table in a particular tournament.

A boxed wager or bet where the user chooses many players who the user likely thinks will finish in a particular order such as an exacta order, a quinella order or trifecta order. If any of the players or entrants finish in the desired order then the user wins the wager.

A keyed wager or bet is an exacta, quinella, or trifecta wager were the user selects a particular player to finish in a given position or placement and having several other players or entrants finish in other spots.

Once the wagers are set the account users can view the tournament play on the wagering system 10 FIG. 1, or can watch the tournament play on various media devices such as television sets, personal digital assistants, and other Internet locations.

Therefore I claim

1. A system for providing pari-mutuel wagering on contests having a large number of entrants, said system comprising:
a. a plurality of wagering events each configured around a particular contest, said wagering events including, a plurality of pari-mutuel wagering events, a plurality of exotic wagering events,
b. said pari-mutuel wagering events each having a plurality of individual entrant wagers, a plurality of group entrant wagers, said individual entrant wagers provided for a first range of wagers on a plurality of entrants in the contest, said group entrant wagers provided for a second range of wagers on the remaining entrants in the contest, said exotic wagering events each including a plurality of wagers to choose a plurality of entrants to place in various positions within the contest.

2. The system according to claim 1 wherein the plurality of entrants placing in various positions in the contest include choosing:
a. six entrants to place in the contest,
b two entrants to place in exact order in the contest,
c. two entrants to place in any order in the contest,
d. three entrants to place in exact order in the contest,
e. many entrants to place in a particular order.

3. The system according to claim 1 wherein said contests include at least one of the following:
a. a poker playing tournament,
b. a billiards/pool playing tournament,
c. a golf tournament,
d. an automotive race,
e. a motorcross race,
f. a marathon,
g. a tennis tournament.

4. The system according claim 1 wherein said first range of wagers is for:
a. a series of top ranked entrants,
b. a series of bottom ranked entrants,
c. a series of randomly ranked entrance.

5. The system according to claim 1 wherein said first range of wagers is for at least 25 of a series of top ranked entrants.

6. The system according to claim 1 wherein said first range of wagers is for at least 25 of a series of the bottom ranked entrants.

7. The system according to claim 1 wherein said first range of wagers is for at least 25 of the entrants.

8. The system according to claim 1 wherein said group entrant wagers include a second range of 26 wagers for the remaining entrants in the contest.

9. The system according to claim 1 wherein said second range of 26 wagers is further categorized alphabetically.

10. The system according to claim 1 wherein said second range of wagers is further categorized by nationality.

11. The system according to claim 1 wherein said second range of wagers includes a series of sub group entrant wagers, said series of sub group entrant wagers further defined alphanumerically.

12. The system according to claim 1 wherein said second range of wagers is further categorized by geographic location.

13. The system according to claim 1 wherein said second range of wagers is further categorized by a ranking system.

14. A system for providing pari-mutuel wagering on contests having a large number of entrants, said system having a wagering server, a plurality of clients, the wagering server connected to a network, the plurality of clients connected to the network and having inter operability with the wagering server, the system further having a plurality of contest sites, banks, cellular systems, and ATM systems, the system further comprising:
a. the wagering server having a wagering application, the wagering application having a wagering database, the wagering application having a plurality of sub applications, the sub applications including a wagering front end application and a wagering back end application,
b. the wagering database further having a plurality of class objects including:
(i) a class of wagering back end objects, a class of wagering front end objects, the class of wagering back end objects including a series of input objects and a series of report objects,
(ii) the class of wagering front end objects including a series of account set up objects and a series of account display objects,
c. the wagering back end application configured to access the class of wagering back end objects including the series of input objects and series of report objects to create a plurality of wagering events around said contests, said wagering events including pari-mutuel wagering events and exotic wagering events,
d. said pari-mutuel wagering events each having a plurality of individual contestant wagers, a plurality of group contestants wagers, said individual contestant wagers provided for a first range of wagers on a plurality of entrants in the contest, said group contestant wagers provided for a second range of wagers on the remaining entrants in the contest,
e. said exotic wagering events each including a wager to choose six entrants to place in the contest, choose two entrants to place in an exact order in the contest, choose two entrants to place in any order in the contest, choose three entrants to place an exact order in the contest.

15. The system according to claim 14 wherein the wagering server further comprises a contest site application, the contest site application having a contest site database, the contest site application accessing a plurality of contest site objects contained within the contest site database, the contest site objects including a contest site front end object, a contest site back end object, the contest site front end configured to be run at a client located at the contest site, the contest site back end object configured to send and receive information to and from the contest site front end client.

16. The system according to claim 14 wherein the wagering server further comprises a banking application having a banking database, the banking database further comprising a series of banking objects including a banking front end, and a banking back end, the banking application configured to be run on one of the client's located within one of the system banks.

17. A system for providing users pari-mutuel wagering on contests having a large number of entrants, said system comprising:
a. a plurality of wagering events each configured around a particular contest, said wagering events including a plurality of pari-mutuel wagering events and a plurality of exotic wagering events,
b. said pari-mutuel wagering events each having a plurality wagers divided into a plurality of individual entrant wagers and a plurality of group entrant wagers, said individual entrant wagers provided for a first range of wagers on a plurality of entrants in the contest, said group entrant wagers provided for a second range of wagers on the remaining entrants in the contest,
c. each wager in said plurality of wagers having an entrant identifier, a currently pooled wager amount, a currently calculated precut odds, and a currently calculated post cut odds,
d. the wagering event further comprises a total currently pooled wager amount, a house percentage cut, and a total pool post cut wager amount, where the post cut odds for a particular wager are calculated by dividing the total pool post cut wager amount by the individual currently pooled wager amount,
e. said exotic wagering events each including a plurality of wagers to choose six entrants to place in the contest, a plurality of wagers to choose two entrants to place in exact order in the contest, a plurality of wagers to choose two entrants to place in any order in the contest, a plurality of wagers to choose three entrants to place in exact order in the contest.

18. A method for conducting pari-mutuel wagering on contests having a large number of entrants, said method comprising:
a. providing a plurality of wagering events each configured around the particular contest, said wagering events including a plurality of pari-mutuel wagering events and a plurality of exotic wagering events,
b. providing for said pari-mutuel wagering events a plurality of individual entrant wagers and a plurality of group entrants wagers, providing for said individual entrant wagers a first range of wagers on a plurality of entrants in the contest,
c. providing for said group entrants wagers a second range of wagers on the remaining entrants in the contest,
d. providing exotic wagering events each including a plurality of wagers to choose a plurality of entrants to place in various positions within the contest.

19. The method according to claim 18 wherein the plurality of entrants placing in various positions in the contest includes choosing:
a. six entrants to place in the contest,
b. two entrants to place in exact order in the contest,
c. two entrants to place in any order in the contest,
d. three entrants to place in exact order in the contest,
e. many entrants to place in a particular order.

20. A method for providing pari-mutuel wagering on contests having a large number of entrants, said method providing a wagering server, a plurality of clients, the wagering server connected to a network, the plurality of clients connect to the network and having interoperability with the wagering server, a method further connecting a plurality of contests sites, banks, cellular systems, and ATM systems to the network, said method further comprising:
a. providing a wagering application on the wagering server, the wagering application having a wagering database, the wagering application further having a plurality of sub applications, the sub applications including a wagering front end application and a wagering backend application,
b. providing in the wagering database a plurality of class objects including:
c. a class of wagering backend objects and a class of wagering front end objects, the class of wagering backend objects including a series of input objects and a series of report objects,
d. the class of wagering front end objects including a series of account set up objects in a series of account display objects,
e. the wagering backend application accessing the class of wagering backend objects including, accessing the series of input objects, accessing the series of report objects, and creating a plurality of wagering events each configured around the particular contest, said wagering events including a plurality of pari-mutuel wagering events and a plurality of exotic wagering events,
f. providing for said pari-mutuel wagering events, a plurality of individual entrant wagers and a plurality of group entrants wagers,
g. providing for said individual entrant wagers a first range of wagers on a plurality of entrants in the contest,
h. providing for said group entrants wagers a second range of wagers on the remaining entrants in the contest,
i. providing a set of exotic wagers including, choosing six wagering events to place in the contest, choosing two wagering events to place in exact order in the contest, choosing two wagering events to place in any order in the contest, choosing three wagering events to place in exact order in the contest.

21. A means for providing pari-mutuel wagering on contests having a large number of entrants, said means comprising:
a. a plurality of wagering events each configured around a particular contest, said wagering events including, a plurality of pari-mutuel wagering events, a plurality of exotic wagering events,
b. said pari-mutuel wagering events each having a plurality of individual entrant wagers, a plurality of group entrant wagers, said individual entrant wagers provided for a first range of wagers on a plurality of entrants in the contest, said group entrant wagers provided for a second range of wagers on the remaining entrants in the contest,
c. said exotic wagering events each including a plurality of wagers to choose a plurality of entrants to place in various positions within the contest.
